(19) United States
(12) Patent Application Publication
(10) Pub. No.: US 2020/0122667 A1
(43) Pub. Date: Apr. 23, 2020

(54) Retractable Inflatable Lap Belt

(71) Applicant: Key Safety Systems, Inc., Sterling Heights, MI (US)

(72) Inventors: Jeffrey Young, Bruce Township, MI (US); Ryan Atkinson, Rochester, MI (US); John J Pollard, Imlay City, MI (US)

(21) Appl. No.: 16/166,662

(22) Filed: Oct. 22, 2018

(51) Int. Cl. B60R 21/18; A44B 11/25; B60R 22/12; B60R 22/28

(52) U.S. Cl. CPC B60R 21/18; A44B 11/2561; B60R 22/28; B60R 22/12; A44B 11/2569

(57) ABSTRACT

A seat belt system 10 has a retractor 28; a lap belt 14, an inflator 200, a buckle 210 and a tongue 220. The flexible, retractable inflatable lap belt 14 is attached to the retractor 28. The lap belt 14 protectively houses an inflatable member including an airbag 116 which includes a feed or fill hose 118. The buckle and tongue are configured to receive and transmit inflation gas from the inflator 200 to the lap belt 14. The airbag 116 is located at a fixed distance from the buckle 210 and when activated the inflation gas flows through the seat belt buckle 210 into the tongue 220 and then into the airbag 116 which is fixedly located on the lap belt 14 at the fixed distance.

### BACKGROUND AND SUMMARY OF THE INVENTION

The present invention relates to inflatable seatbelts or harnesses and more particularly to a safety restraint system including a 2-point lap belt positioned across the pelvis of a seated occupant.

Seat belt systems comprising a woven belt of material have been used extensively in land vehicles and aircraft for many years. In the 1970s it was proposed that an inflatable belt could provide additional protection for the seated occupants. Recently such systems have received commercial acceptance. Automotive vehicles are required to have what is called a 3-point safety restraint system. U.S. Pat. No. 7,708,312 is representative of one type of 3-point safety restraint system having an inflatable shoulder belt. With regard to aircraft and in particular commercial and general aviation, the 2-point seat restraint system is commonly used. The typical 2-point safety restraint system comprises a lap belt, one end of which includes a tongue, the other end of which is anchored to an appropriate location in the aircraft or land vehicle. The tongue is inserted within a buckle, the buckle is connected to another anchor typically mounted to the seat frame or floor. In an inflatable restraint system, the lap belt inflates when a certain dynamic condition is achieved. U.S. Pat. No. 5,984,350 and patent application US20170225788 are representative of this class of 2-point safety restraint systems. One deficiency of prior art systems is when the tongue is inserted within the buckle there can be an extra length of the lap belt (slack) not tightly placed about the occupant. This slack must be removed manually in these prior art systems requiring the occupant to pull the belt tight about him or herself. Once the slack is removed an amount of seat belt is left to lie on the occupant's lap. One benefit of the present invention is it employs a retractor to automatically remove this slack about the occupant, eliminating need for a belt extender; additionally, there will be no extra webbing on the occupant's lap. Another advantage of the present invention is the airbag will be located at a fixed distance from the buckle. In the present invention inflation gas flows through the seat belt buckle, into a tongue and then into the airbag which is fixedly located on the lap belt providing for a more robust safety system.

### BRIEF DESCRIPTION OF THE DRAWINGS

FIG. 1 is a perspective view of a vehicle seat with a 2-point retractable inflatable lap belt;

FIG. 1A-1E show further details of the present invention.

FIG. 2 illustrates the lap belt in a retracted position.

FIG. 3 is a side view of a seat showing locations for a seat belt retractor as well as an inflated airbag.

### DETAILED DESCRIPTION OF THE DRAWINGS

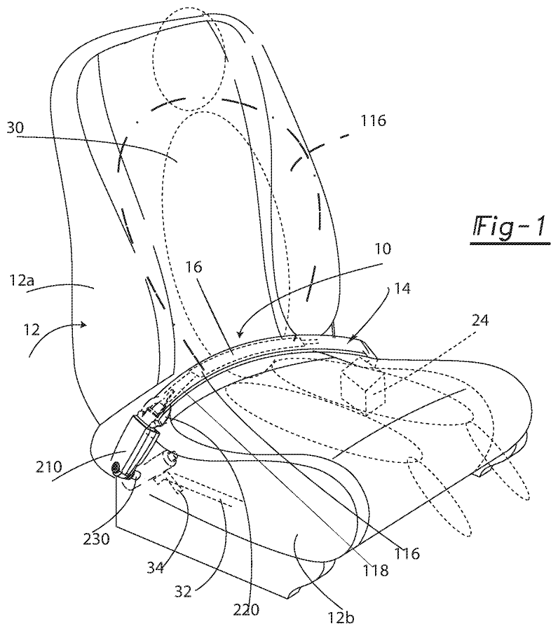

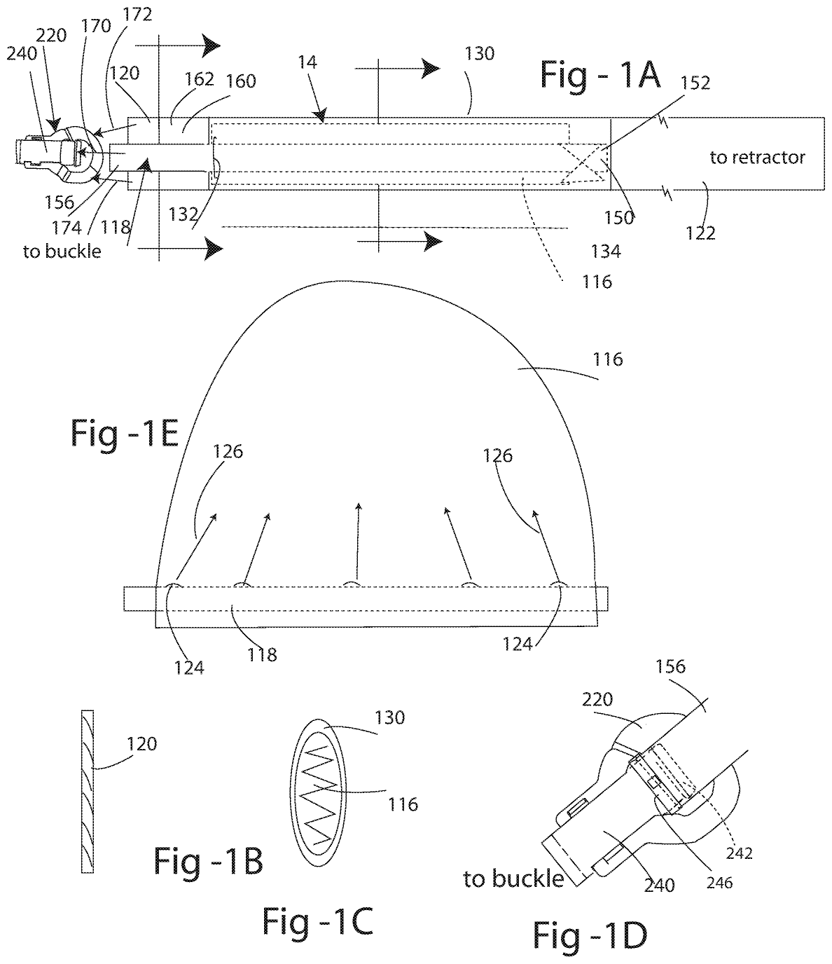

FIG. 1 shows a seat belt system 10 comprising a lap belt 14 shown in its latched position extending across a seated occupant 30, shown in phantom line. The lap belt lap belt 14 protectively houses an inflatable member 16 including an airbag 116 which includes a feed hose 118. The lap belt is constructed using a known weaving technique which can create a lap belt with a first portion of a one-layer woven seat belt adjacent to a hollow woven portion which is adjacent to a second portion of a one-layer woven seat belt. As shown in FIGS. 1A, 1B and 1C the lap belt includes a first and a second one-layer woven portion 120 and 122 respectively. The lap belt 14 includes a hollow woven section 130 connecting portions 120 and 122. FIGS. 1B and 1C illustrate cross-sectional views. As is known in the art the hollow portion is woven with a weak thread or threads enabling the hollow section to be easily torn as the airbag inflates. As mentioned the inflatable member 16 includes an airbag 116 and fill hose 118 which may be an integral portion of the airbag or a separate tubular member. As shown in FIG. 1E, the fill hose 118 includes a plurality of openings or vents 124 which communicate inflation gas to the airbag 16 as shown by arrows 126. The hollow woven portion 130 of the lap belt 14 includes an opening 132. The airbag 116 is folded into a compact shape and the airbag and feed hose 118 are inserted into opening 132 and moved into the hollow woven portion 130. A portion of the airbag 116 and tube 118 are sewn to the hollow portion of the lap belt. Numeral 152 shows an exemplary sew pattern. With the airbag 116 located in the hollow portion 130 of the lap belt 14, an end 156 of the tube 118 will be loosely positioned next to portion 120. The folded airbag is shown in FIG. 10 with the hollow portion 130. Arrow 170 diagrammatically shows the end 156 of tube 118 secured to a tube 240 of the tongue 220. Arrows 172 and 174 show a portion of the end 120 of the lap belt which is adjacent to the end 156 of the tube secured to a ring 220 of the tongue 220. FIG. 1 also shows airbag 116 using staggered phantom lines in an inflated condition.

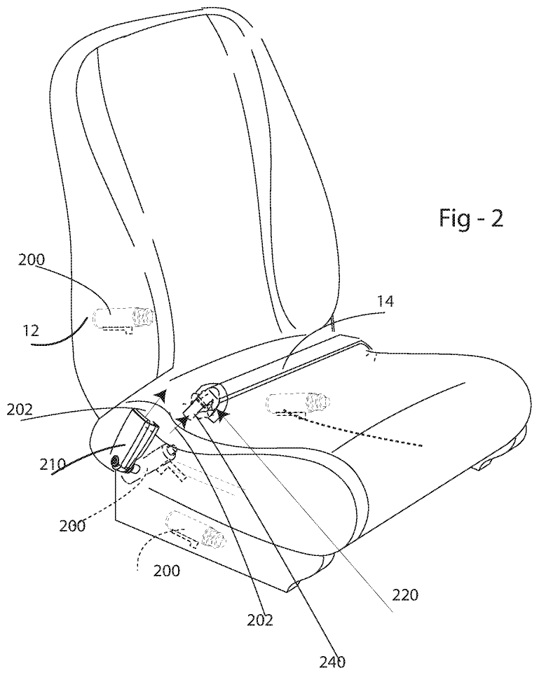

The system further includes an inflator 200, a buckle 210 and tongue 220. The buckle and tongue are configured to receive and transmit inflation gas from the inflator to the lap belt. The buckle and tongue can be those used in U.S. Pat. No. 7,708,312 which is incorporated herein by reference. The buckle 210 is secured for example to a seat frame adjacent the seat cushion 12b and more particularly to the seat frame or other support member or to the floor upon which the seat 12 is mounted. The inflator 200 is positioned out of view. As illustrated the inflator is positioned under the seat cushion 26 or at some other concealed location and is in pneumatic communication with the buckle 210 such as by a hollow conduit 230. The inflator is attached to the seat frame 32 by a bracket 34. The inflator 200 used in this system 10 is preferably what is known as a cold gas inflator which comprises a tank or pressure vessel filled with compressed gas. The inflator is pyrotechnically opened in a known manner to cause the compressed gas to flow through the buckle into a metal hollow tube 240, which is part of the tongue 220, and then into the tube 118 and airbag 116. This relationship is partially shown in FIG. 2 and FIG. 1A. Arrow 202 (see FIG. 2) shows inflation gas generated by the inflator exiting the buckle 210 and arrow 204 shows the inflation gas entering the tongue 220. Reference is briefly made FIG. 1D which shows end 156 of tube 118 placed over end 242 of the metal hollow tube 240 and secured to the tube by a damp 246

Referring again to FIG. 2, the lap belt 14 is shown in its retracted state lying upon the seat cushion. Additionally FIG. 2 shows a number of alternate locations for the inflator 200. These locations may be toward the center of the seat cushion, in the seat back 12a, in the support 82 of the seat.

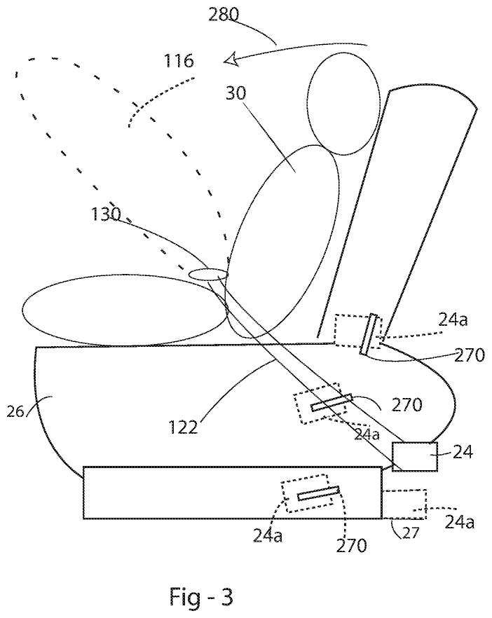

In FIG. 1, one of the mounted positions of the retractor 24 is identified as exterior to and at a lower edge of the cushion. FIG. 3 identifies some concealed mounting locations 24a of the retractor 24 such as within the bottom of the seat back, in the seat cushion, inside of the seat support and on a support surface 27, which supports the seat. Each of these concealed mounting locations includes an opening ring 270. FIG. 3 also shows a rectangular ring 270 which overlays an opening in the upholstery through which the end 122 of the lap belt 14 extends. FIG. 3 also shows the original location of the retractor 28 at the lower-side-back of the seat cushion with the extending lap belt portion 122 and the hollow portion positioned in front of the occupant 30. Additionally, the inflated airbag 116 is shown. Arrow 280 is indicative of the motive of the occupant 30 towards the inflated airbag during a crash.

Many changes and modifications in the above-described embodiment of the invention can, of course, be carried out without departing from the scope thereof. Accordingly, that scope is intended to be limited only by the scope of the appended claims.

1. A seat belt system comprises:
a retractor;
a flexible, retractable inflatable lap belt attached to the retractor, wherein the lap belt lap belt protectively houses an inflatable member including an airbag which includes a feed or fill hose;
an inflator;
a buckle;
a tongue, the buckle and tongue are configured to receive and transmit inflation gas from the inflator to the lap belt; and
wherein the airbag is located at a fixed distance from the buckle and when activated the inflation gas flows through the seat belt buckle into the tongue and then into the airbag which is fixedly located on the lap belt at the fixed distance.

2. The seat belt system of claim 1 wherein the lap belt is constructed using a known weaving technique which can create the lap belt with a first portion of a one-layer woven seat belt adjacent to a hollow woven portion which is adjacent to a second portion of a one-layer woven seat belt.

3. The seat belt system of claim 1 wherein the lap belt includes a first and a second one-layer woven portion and respectively.

4. The seat belt system of claim 3 wherein the lap belt includes a hollow woven section connecting portions.

5. The seat belt system of claim 4 wherein the hollow portion is woven with a weak thread or threads enabling the hollow section to be easily torn as the airbag inflates.

6. The seat belt system of claim 1 wherein the feed or fill hose being an integral portion of the airbag or a separate tubular member.

7. The seat belt system of claim 1 wherein the feed or fill hose includes a plurality of openings or vents which communicate inflation gas to the airbag.

8. The seat belt system of claim 4 wherein the hollow woven portion of the lap belt includes an opening and the airbag is folded into a compact shape and the airbag and feed hose are inserted into opening and moved into the hollow woven portion.

9. The seat belt system of claim 8 wherein a portion of the airbag and tube are sewn to the hollow portion of the lap belt.

10. The seat belt system of claim 9 wherein the end of tube secured to a tube of a tongue, a portion of the end of the lap belt which is adjacent to an end of the tube secured to a ring of the tongue.

11. The seat belt system of claim 1 wherein the buckle is secured to a seat frame adjacent the seat cushion or other support member or to the floor upon which the seat is mounted.

12. The seat belt system of claim 1 wherein the inflator is positioned under the seat cushion or at some other concealed location and is in pneumatic communication with the buckle by a hollow conduit.

13. The seat belt system of claim 1 wherein the inflator used in the system 10 is a cold gas inflator which comprises a tank or pressure vessel filled with compressed gas, and the inflator is pyrotechnically opened to cause the compressed gas to flow through the buckle into the tube, which is part of the tongue, and then into the tube and airbag.

14. The seat belt system of claim 1 wherein the end of tube placed over end of the metal hollow tube and secured to the tube by a clamp.

15. The seat belt system of claim 1 wherein the mounted position of the retractor is exterior to and at a lower edge of the cushion.

16. The seat belt system of claim 1 wherein some concealed mounting locations of the retractor can be within the bottom of the seat back, in the seat cushion, inside of the seat support and on a support surface, which supports the seat, each of these concealed mounting locations includes an opening ring, the ring overlays an opening in the upholstery through which the end of the lap belt extends.
